(19) United States
(12) Patent Application Publication
(10) Pub. No.: US 2011/0001100 A1
(43) Pub. Date: Jan. 6, 2011

(54) Tool and method for installing new cable

(75) Inventors: Hidehiko Ogawa, Fukuchiyama (JP); Kazuhisa Matsuo, Funabashi (JP)

Correspondence Address: AKERMAN SENTERFITT, 8100 BOONE BOULEVARD, SUITE 700, VIENNA, VA, 22182-2683, US

(73) Assignee: Hien Electric Industries, Ltd., Osaka (JP)

(21) Appl. No.: 12/801,965

(22) Filed: Jul. 6, 2010

(30) Foreign Application Priority Data
Jul. 6, 2009 (JP) 2009-159494

(51) Int. Cl. G02B 6/48; H02G 1/02

(52) U.S. Cl. 254/134.3 R

(57) ABSTRACT

A new cable installation tool for installing a new cable between two points where the existing support line is installed includes: a plurality of S-shaped guides; a connection rope that connects the plurality of S-shaped guides; and a towrope that is bound to the end of the connection rope. A method for installing a new cable between two points where the existing support line is installed using the new cable installation tool includes: (1) hooking upper curved portions of a plurality of S-shaped guides to the existing support line; (2) binding one end of a connection rope to one electric pole or a portion of the existing support line in the vicinity of one electric pole; (3) hooking a new cable on lower curved portions of the plurality of S-shaped guides; (4) binding a terminal of the new cable to the other end of the connection rope; (5) drawing a towrope bound to the other end of the connection rope to another electric pole; (6) fixing the new cable to two target electric poles; and (7) collecting the new cable installation tool.

### BACKGROUND OF THE INVENTION

1. Field of the Invention

The present invention relates to a tool and a method for installing a new cable using the existing cable that is installed between electric poles or between a home and an adjacent electric pole.

2. Description of the Related Art

In recent years, with wide spread of broadband services, such as video delivery and data communication, the number of fiber-to-the-home (hereinafter, referred to as FTTH) subscribers have increased. In the FTTH system, for example, an optical cable, which is called a drop optical cable, has generally been used to draw optical fiber from a trunk optical cable into the subscriber's home through a closure. For example, the drawing of the optical fiber into the home is by branching into the optical fibers from the trunk optical cable installed between the electric poles in the closure and connecting the branched optical fiber to the drop optical cable.

As a new cable installation method according to the related art, a method has been proposed which uses a draw-in drop optical cable which comprise a cable main body and a suspension portion that are integrally connected to and can be easily cut off each other at the neck thereof and fixes both ends of the suspension portion to two installation points to suspend and support the cable main body. For example, when the cable is drawn from the electric pole into the home, one end of a new cable is fixed to the electric pole that is connected to a trunk optical cable, and the other end of the new cable is extended and drawn to a target electric pole or the home. Then, the other end of the cable is fixed to the home and the new cable is stretched. Then, the cable is connected to an apparatus in the home. In this case, until a new cable is stretched, the new cable is temporarily placed on the ground or the road.

For example, the above-mentioned installation operation has the following issues. (1) When the cable is installed across the road, the cable placed on the road obstructs traffic. (2) Traffic control persons are needed in order to prevent, for example, an accident involving people or vehicles. (3) When the cable is installed across a farm field, the cable damages crops. (4) A construction schedule is delayed.

Therefore, for example, a method has been proposed which winds an optical cable in a spiral shape on a support line, such as a messenger wire, an existing telephone line or power line and draws the optical cable, into the home (for example, see Japanese Patent Application Laid-Open (JP-A) Nos. 2002-142319 and 2009-48128).

In the method that winds the optical cable in a spiral shape on the support line and draws the optical cable into the home, the operation of the installation of the optical cable is complicated, and in some cases, a spiral portion of the drop optical cable does not come into close contact with the support line with a large gap therebetween. In addition, a suspension accident caused by vehicles or the cutting of a cable caused by birds is likely to occur.

### SUMMARY OF THE INVENTION

The present invention has been made in order to solve the above-mentioned issues and an object of the invention is to provide a tool and a method for effectively installing a new cable using, for example, an existing electric cable.

<1> According to the present invention, there is provided a new cable installation tool for installing a new cable between two points where a support line is installed, including a plurality of S-shaped guides, a connection rope that connects the plurality of S-shaped guides, and a towrope that is bound to an end of the connection rope.

<2> The S-shaped guide may be made of a wire rod and include a stopper for fixing the connection rope provided in a central portion of an S shape.

<3> The S-shaped guide may be a resin plate and include a downward protrusion that is provided in a central portion of an S shape and a connecting hole that is provided in a lower portion of the S shape.

<4> According to another aspect of the invention, there is provided a method for installing a new cable between two points where an existing support line is installed using the new cable installation tool according to the aspects <1>, including hooking upper curved portions of the plurality of S-shaped guides on the existing support line, binding one end of the connection rope to one electric pole or a portion of the existing support line in the vicinity of one electric pole, hooking a new cable on lower curved portions of the plurality of S-shaped guides, binding a terminal of the new cable to the other end of the connection rope, towing the towrope bound to the other end of the connection rope to another electric pole, fixing the new cable to the two electric poles at target points, and collecting the new cable installation tool.

When the installation tool and the installation method according to the above-mentioned aspects of the invention, the efficiency of installation is higher than that of the installation method according to the related art and a new cable is installed independently from the existing cable. Therefore, it is possible to solve various issues caused by a gap between the existing support line and a new cable when the new cable is wound in a spiral shape on the existing support line. Even though there are ground obstacles, such as a road, a farm field, and a pond, between two points where the cable is installed, it is possible to smoothly install a new cable regardless of the obstacles. In addition, traffic control persons are not needed and the installation schedule is not delayed.

### BRIEF DESCRIPTION OF THE DRAWINGS

FIG. 1 is a front view schematically illustrating an a-type S-shaped guide;

FIG. 2 is a diagram schematically illustrating a connection rope having a plurality of S-shaped guides connected thereto;

FIG. 3 is a front view schematically illustrating a b-type S-shaped guide;

FIG. 4 is a diagram schematically illustrating a connection rope having a plurality of S-shaped guides connected thereto;

FIG. 5 is a front view schematically illustrating a method for installing a new cable;

FIG. 6 is a front view schematically illustrating completion of the installation of a new cable; and

FIG. 7 is a front view schematically illustrating collection of the S-shaped guides after a new cable is completely installed.

### DETAILED DESCRIPTION OF THE EMBODIMENTS

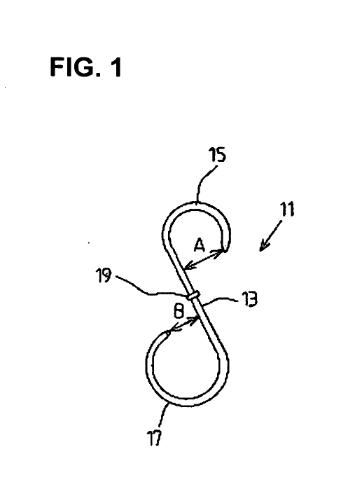

The present invention relates to a tool and a method for installing a new cable using an existing cable or an existing support line, such as a messenger wire, installed between electric poles. A new cable installation tool according to the invention includes a plurality of S-shaped guides, a connection rope that connects the plurality of S-shaped guides, and a towrope that is bound to an end of the connection rope. FIG. 1 illustrates an example of the S-shaped guide (hereinafter, referred to as an a-type S-shaped guide). The a-type S-shaped guide illustrated in FIG. 1 is made of a wire rod. It is preferable that an a-type S-shaped guide 11 includes a stopper 19 for fixing the connection rope to a central portion of the S shape.

As illustrated in FIG. 1, the a-type S-shaped guide is formed in an S shape including a straight portion 13, an upper curved portion 15, and a lower curved portion 17 (the structure of the S shape aforementioned is also applied to other types, which will be described below). The a-type S-shaped guide may be made of any material that has sufficient strength not to be damaged during a general installation operation and has a smooth surface. The a-type S-shaped guide is preferably made of reinforced plastic or a hard steel wire rod, more preferably, a hard steel wire rod. When the hard steel wire rod is used, it is preferable to perform plating to prevent corrosion.

It is preferable that a distance A between a leading end of the upper curved portion 15 and the straight portion 13 of the a-type S-shaped guide be 1.5 to 6.0 times more than the diameter or the thickness of the existing support line according to a round cable or a flat cable thereof and a distance B between a leading end of the lower curved portion 17 and the straight portion 13 be about 1.5 to 6 times more than the diameter or the thickness of a new cable.

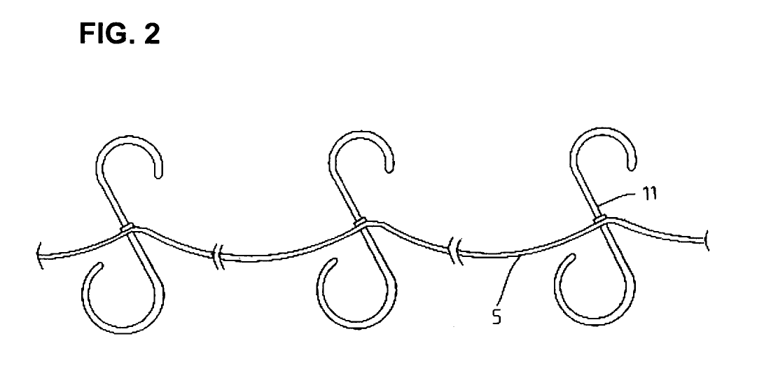

FIG. 2 illustrates a plurality of a-type S-shaped guides that is connected to the connection rope 5 at an appropriate interval. Any one of a three-strand rope (a rope made of three strands twisted together), a cross rope, and a resin-coated rope may be used as the connection rope 5 as long as it has flexibility and strength. Among them, the three-strand rope is preferable in terms of the connection of the a-type S-shaped guide. As a method for connecting the a-type S-shaped guides to the connection rope, the a-type S-shaped guides are inserted between the strands when the connection rope is the three-strand rope. In this case, it is preferable that the stopper 19 be provided as a retainer at the center of the straight portion 13 of the a-type S-shaped guide. When the a-type S-shaped guide is inserted between the strands of the rope 5, the stopper locks the a-type S-shaped guide to the rope and stabilizes it. When ropes other than the three-strand rope are used, a sleeve is provided as a retainer in the a-type S-shaped guide. In this case, the connection rope passes through the sleeve and the sleeve is pressed.

The interval between the plurality of a-type S-shaped guides connected to the connection rope may be arbitrarily selected from the range in which the cable can be smoothly installed, according to, for example, the gradient of the existing support line. When the existing support line is horizontal, the interval is preferably in the range of 50 cm to 300 cm, and more preferably in the range of 100 cm to 200 cm.

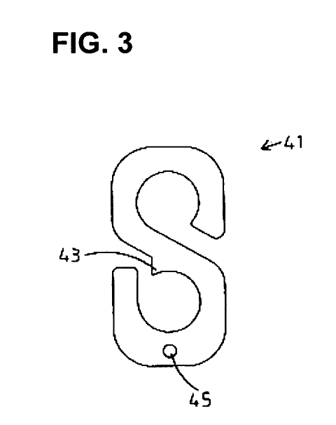

FIG. 3 illustrates another example of the S-shaped guide (hereinafter, referred to as a b-type S-shaped guide). A b-type S-shaped guide 41 illustrated in FIG. 3 is an S-shaped plate made of reinforced plastic and preferably includes a downward protrusion 43 that is provided in a central portion of the S shape and a connecting hole 45 that is provided in a lower portion of the S shape.

It is preferable that the distance A between the leading end of the upper curved portion 15 and the straight portion 13 of the b-type S-shaped guide be 1.5 to 6 times more than the diameter or the thickness of the existing support line according to a round cable or a flat cable thereof and a distance B between a leading end of the lower curved portion 17 and the straight portion 13 be one 1.5 to 6 times more than the diameter or the thickness of a new cable.

The b-type S-shaped guide may be made of any material that has sufficient strength not to be damaged during a general installation operation and has a smooth surface. It is preferable that the b-type S-shaped guide be made of reinforced plastic.

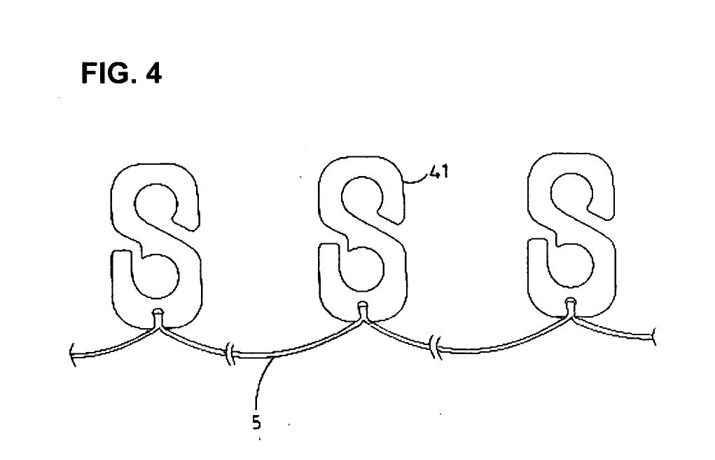

As illustrated in FIG. 4, the connection rope 5 passes through the connecting holes 45 of the b-type S-shaped guides such that the b-type S-shaped guides are arranged at appropriate intervals. Any rope with flexibility and strength may be used as the connection rope 5. It is preferable that a polyester rope with a diameter of 2 mm to 5 mm be used as the connection rope 5 since the rope is inserted into the connecting holes 45 of the b-type S-shaped guides such that the b-type S-shaped guides are connected to the rope. The interval between the S-shaped guides 41 connected to the connection rope may be equal to that between the a-type S-shaped guides.

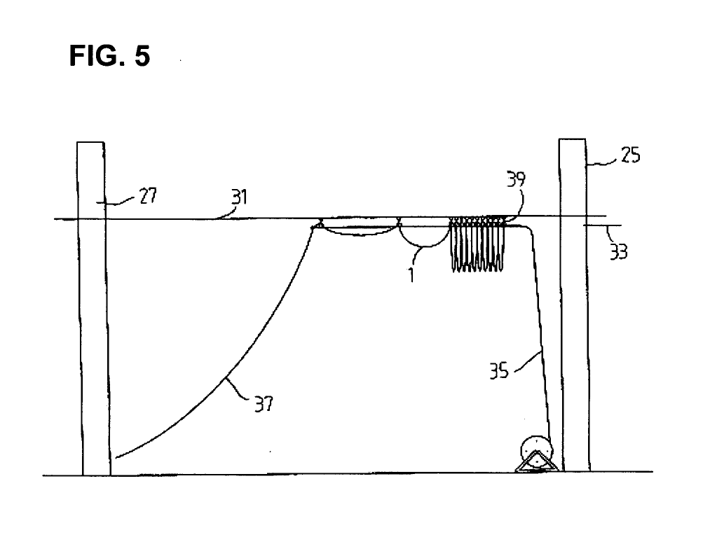

A method for installing a new cable between two points where the existing support line is installed using the new cable installation tool will be described with reference to FIG. 5. In FIG. 5, reference numerals 25 and 27 indicate two electric poles at target points for installing a new cable, and the existing support line 31 is installed between the two electric poles. A terminal 33 of the new cable has already been installed at the electric pole 25.

When a new cable is installed between the electric pole 25 and the electric pole 27, the connection rope 5 to which the S-shaped guides are connected and which has a length that is 0.8 to 1.5 times more than the distance between the electric pole 25 and the electric pole 27 and a towrope 37 with a length that is more than the height of the existing support line 31 from the ground are prepared in addition to the new cable.

The invention is performed as follows. First, the upper curved portions 15 of all of the S-shaped guides connected to the connection rope 5 are hooked to the support line 31. This operation can be performed only one time by arranging the upper curved portions of the S-shaped guides in advance. Then, one end (hereinafter, referred to as a fixed end) of the connection rope 5 is bound to an arbitrary point of the electric pole 25 or an arbitrary point 39 of the support line 31 close to the electric pole 25. The order of the two processes may be reversed.

Then, the terminal of the new cable 35 is bound to an arbitrary point close to the other end (hereinafter, referred to as a free end) of the connection rope 5. Then, the new cable 35 is sequentially hooked on the lower curved portions 17 of the S-shaped guides. This operation can be performed only one time by arranging the S-shaped guides in advance. The order of the two processes may be reversed. The towrope 37 is bound to the free end of the connection rope 5.

Then, in this state, the towrope 37 bound to the free end of the connection rope 5 is towed on the ground such that the free end of the connection rope 5 is guided to the electric pole 27.

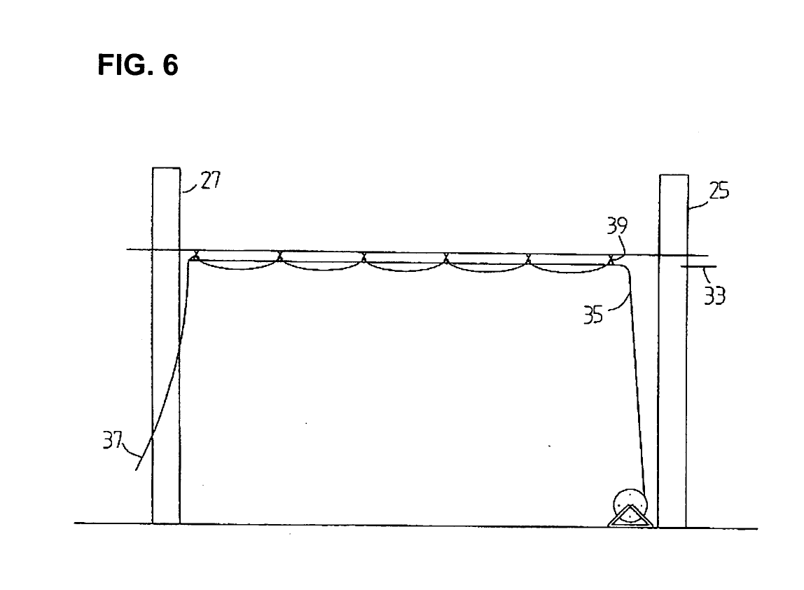

As illustrated in FIG. 6, after the new cable 35 reaches the electric pole 27, the new cable 35 is fixed to the electric pole 25 and the electric pole 27.

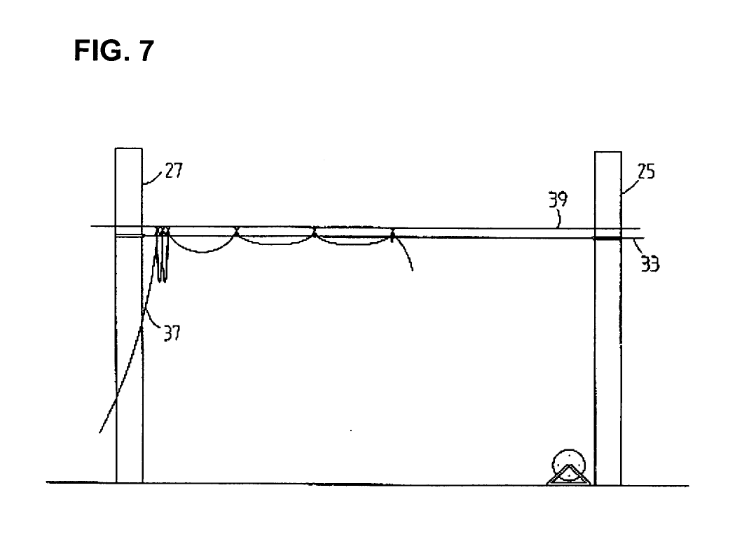

Then, the connection rope 5 is unbound from the arbitrary point 39 of the support line. Then, as illustrated in FIG. 7, the connection rope 5 is drawn to the electric pole 27 and is then collected. In this case, when a rope for drawing the connection rope is bound to the fixed end of the connection rope 5 in advance, it is possible to easily perform the collection operation. In addition, the towrope 37 bound to the free end of the connection rope 5 may be collected to the electric pole 25. In this way, the installation of the new cable 37 is completed.

### EXAMPLES

Next, the present invention will be described in detail with reference to examples, but the invention is not limited to the following examples. In the following examples, as illustrated in FIG. 5, an existing cable 31, which is used as a support line, is installed between the electric pole 25 and the electric pole 27 and a trunk optical cable 33 has already been installed at the electric pole 25. The distance between an electric pole 25 and an electric pole 27 was 50 m and the height of the existing cable 31 from the ground was 5 m.

### Example 1

In Example 1, a round cable with a diameter of 10 mm was used for the existing cable 31. In addition, a two-core optical drop cable with a size of 5.5 mm×2.0 mm was used for a new cable.

FIG. 2 illustrates a portion of a connection rope 5 and S-shaped guides according to Example 1. The length of the connection rope 5 was 50 m. Twenty-five S-shaped guides were connected to the rope 5 at an interval of 2,000 mm. A three-strand rope with a diameter of 6 mm was used for the connected rope.

The S-shaped guide used in Example 1 was a plated hard steel wire rod with a height (C) of 200 mm, a width (D) of 80 mm, and a diameter (E) of 8 mm. The distance A between the straight portion and a leading end of the upper curved portion 15 of the S-shaped guide was 30 mm and the distance B between the straight portion and a leading end of the lower curved portion 17 was 10 mm.

FIG. 5 illustrates a method for installing a new cable using the connection rope 5. First, the upper curved portions of twenty-five S-shaped guides connected to the connection rope 5 were hooked to the support line 31. This operation was performed only one time by arranging the upper curved portions of the S-shaped guides in advance. Then, the fixed end of the connection rope 5 was bound to a portion of the support line 31 that was spaced 1 m from the electric pole 25. In addition, the length of the towrope 37 bound to the free end of the connection rope 5 was 8 m.

Then, the terminal of a new cable 35 was bound to a point that was spaced 0.5 m from the free end of the connection rope 5 and the new cable 35 was sequentially hooked on the lower curved portions 17 of the S-shaped guides. This operation was performed only one time by arranging the lower curved portions of the S-shaped guides in advance.

Then, the towrope 37 bound to the free end of the connection rope 5 was towed on the ground such that the free end of the connection rope 5 was guided to the electric pole 27.

As illustrated in FIG. 6, after the new cable 35 reached the electric pole 27, the new cable 35 was fixed to the electric pole 25 and the electric pole 27. Then, the fixed end of the connection rope 5 was unbound from a connected point 39. Then, as illustrated in FIG. 6, the connection rope 5 was drawn to the electric pole 27 and then collected. In this way, the installation of the new cable 37 was completed.

The work time required for two workers to install a new cable at a distance of 50 m between the electric pole 25 and the electric pole 27 from the carry-in of a new cable drum to the collection operation was 28 minutes.

### Example 2

In Example 2, a flat cable with a size of 10.0 mm×5.5 mm was used for the existing cable 31. In addition, a two-core optical drop cable with a size of 5.5 mm×2.0 mm was used for a new cable.

FIG. 4 illustrates a portion of a connection rope 5 and S-shaped guides according to Example 2. The length of the connection rope 5 was 52 m. Fifty-one S-shaped guides were connected to the connection rope 5 at an interval of 1,000 mm. A polyester rope with a diameter of 3 mm was used for the connection rope 5.

The S-shaped guide used in Example 2 was a high-density polyethylene plate with a height (F) of 86 mm, a width (G) of 43 mm, and a thickness of 3 mm. The distance A between the straight portion and the upper curved portion 15 of the S-shaped guide was 9 mm and the distance B between the straight portion and the leading end of the lower curved portion 17 was 5 mm.

The operation was performed same as Example 1. The work time required for two workers to install a new cable at a distance of 50 m between the electric pole 25 and the electric pole 27 from the carry-in of the new cable drum to the collection operation was 25 minutes.

### Comparative Example

In the new cable installation method according to the related art that draws a terrestrial part for installation without using the cable installation tool according to the invention, the time required for two workers to install a new cable was 42 minutes. In Examples 1 and 2, the cable was installed without crossing the road. However, in the method according to the related art that installs the cable across the road, traffic control persons are needed in addition to the workers. Therefore, the method according to the invention is very efficient.

According to the invention, even though there are ground obstacles, such as a road, a farm field, and a pond, between two points where the cable is installed, it is possible to smoothly and effectively install a new cable regardless of the obstacles.

1. A new cable installation tool for installing a new cable between two points where a support line is installed, comprising:
a plurality of S-shaped guides;
a connection rope that connects the plurality of S-shaped guides; and
a towrope that is bound to an end of the connection rope.

2. The new cable installation tool according to claim 1,
wherein each of the S-shaped guides is made of a wire rod and includes a rope retainer provided in a central portion of an S shape.

3. The new cable installation tool according to claim 1,
wherein each of the S-shaped guides is a resin plate and includes a downward protrusion that is provided in a central portion of an S shape and a connecting hole that is provided in a lower portion of the S shape.

4. A method for installing a new cable between two points where an existing support line is installed using a new cable installation tool for installing a new cable between two points where a support line is installed, the new cable including a plurality of S-shaped guides, a connection rose that connects the plurality of S-shaped guides, and a towrope that is bound to an end of the connection rope, the method comprising:
hooking upper curved portions of the plurality of S-shaped guides on the existing support line;
binding one end of the connection rope to one electric pole or a portion of the existing support line in the vicinity of one electric pole;
hooking a new cable on lower curved portions of the plurality of S-shaped guides;
binding a terminal of the new cable to the other end of the connection rope;
towing the towrope connected to the other end of the connection rope to another electric pole;
fixing the new cable to the two electric poles at target points; and
collecting the new cable installation tool.
